(19) United States
(12) Patent Application Publication
(10) Pub. No.: US 2015/0159040 A1
(43) Pub. Date: Jun. 11, 2015

(54) LOW-VISCOSITY PHENOLIC DIGLYCIDYL ETHERS FOR EPOXY COATING APPLICATIONS

(71) Applicant: Dow Global Technologies LLC, Midland, MI (US)

(72) Inventors: Scott D. Boelter, Saginaw, MI (US); Ray E. Drumright, Midland, MI (US); Tzu-Chi Kuo, Midland, MI (US); Peter Margl, Midland, MI (US)

(21) Appl. No.: 14/406,335

(22) PCT Filed: Jun. 10, 2013
(86) PCT No.: PCT/US2013/044883

§ 371 Date: Dec. 8, 2014

Related U.S. Application Data
(60) Provisional application No. 61/657,964, filed on Jun. 11, 2012.

(51) Int. Cl. C09D 163/00

(52) U.S. Cl. CPC C09D 163/00

(57) ABSTRACT

The present invention provides mononuclear aromatic diglycidyl ether epoxy resins, such as alkyl resorcinols and alkyl hydroquinones, having one or two alkyl containing, cycloalkyl containing, alkoxy containing, alkylsulfide containing, alkylsilyl containing or alkylether containing groups, two alkylamino containing groups, one N-heterocycloalkyl group, and mixtures thereof, as well as two component liquid coating compositions comprising as an epoxy component the epoxy resins, and, as a second component, a hardener. Coating compositions of the present invention provide low viscosity coating compositions even at 100% solids and enable the use of epoxy coating compositions in remote field applications.

The present invention relates to low viscosity mononuclear aromatic diglycidyl ethers, to liquid coating compositions from low viscosity mononuclear aromatic diglycidyl ethers, to methods of applying the liquid compositions and coatings made therefrom. More particularly, it relates to two component compositions comprising (cyclo)alkyl or alkoxy group containing diglycidyl ethers of mononuclear aromatic diphenols, such as alkyl hydroquinone or alkyl resorcinol, and a hardener component, which when mixed can be easily applied as field coatings to substrates at 85 wt. % solids or higher, preferably, 95 wt. % or higher, e.g. 100 wt. % solids.

Previously, coating applicators have dealt with the problem of poor applicability, i.e. the sprayability or paintability, of epoxy coatings by adding either an organic solvent to an otherwise high-viscosity epoxy formulation, or by adding reactive diluents, or using heated application equipment. Such solvents, e.g. xylene, are generally polluting, and are considered volatile organic compounds (VOCs) as they evaporate in use. Diluents, usually organic compounds with active hydrogens (e.g., alcohol such as benzyl alcohol) or epoxy functional compounds such as cresol glycidyl ether or butanediol diglycidyl ether, can be incompletely reacted into the epoxy coating during cure resulting in organic volatiles (VOCs) and/or deterioration in properties in the final coating due to disruption of crosslinking and/or plasticization of the coating film. Heated plural component application equipment is impractical to use and expensive to buy and maintain. Without the use of added solvents or diluents, the resulting epoxy coating materials can only be pumped or conveyed short distances, which limits their usefulness in field applications, such as for metal structures, like water towers or bridges, and leads users to add even more VOCs to the coating composition.

International patent publication no. WO1999062894A2, to Dow Chemical, discloses processes for making glycidyl ether compounds via oxidation of allyl ether precursors. The compounds of the present invention fall within the broad scope of the many millions of glycidyl ether compounds that could be made by the disclosed process (see Formula XI on p. 59); however, the Dow publication does not disclose the glycidyl ether compounds of the present invention or the high solids coatings of the present invention or their applications.

The present inventors have sought to solve the problem of providing low viscosity epoxy coating compositions without the necessity of employing more than a limited amount of organic solvents or reactive diluents, or high application temperatures.

The present invention enables epoxy coatings to meet rigorous sustainability targets with respect to solvent content while making application easier and enabling more formulation flexibility while maintaining desirable coating performance properties.

### STATEMENT OF THE INVENTION

1. In accordance with the present invention, two component liquid coating compositions comprise as an epoxy component one or more compounds chosen from a C₂ to C₁₈ alkyl group containing mononuclear aromatic diglycidyl ether, a C₂ to C₁₈ cycloalkyl group containing mononuclear aromatic diglycidyl ether, a C₂ to C₁₈ alkoxy group containing mononuclear aromatic diglycidyl ether, and mixtures thereof, and, as a second component, a hardener, such as a polyamine, wherein the coating composition has a solids content of 85 wt. % or higher, preferably, 95 wt. % or higher, or, more preferably, 97 wt. % or higher, e.g. 100 wt. %, such that when the epoxy component and the second component are mixed to form a coating composition the resulting coating composition has an initial viscosity (on mixing) at 25° C. (Brookfield CAP 2000+ high-shear cone & plate viscometer) of from 50 to 3,000 cPs, or, preferably, from 50 to 1000 cPs, or, more preferably, 100 or more cPs. The viscosity (Brookfield CAP 2000+ high-shear cone & plate viscometer) of the epoxy component alone ranges from 50 to 3,000 cPs, or, preferably, from 50 to 1000 cPs, or, more preferably, 100 or more cPs at 25° C.

2. The two component liquid coating compositions may comprise as an epoxy component one or more compounds chosen from alkyl group containing compounds, such as, for example, a C₂ to C₁₈ alkyl group containing hydroquinone diglycidyl ether, a C₂ to C₁₈ alkyl group containing resorcinol diglycidyl ether, a C₂ to C₁₈ alkylsulfide group containing mononuclear aromatic diglycidyl ether, such as a C₂ to C₁₈ alkylsulfide group containing hydroquinone diglycidyl ether or a C₂ to C₁₈ alkylsulfide group containing resorcinol diglycidyl ether; a C₂ to C₁₈ alkylamino group containing mononuclear aromatic diglycidyl ether, such as a C₂ to C₁₈ alkylamino group containing hydroquinone diglycidyl ether or a C₂ to C₁₈ alkylamino group containing resorcinol diglycidyl ether; a C₂ to C₁₈ alkylsilyl group containing mononuclear aromatic diglycidyl ether, such as a C₂ to C₁₈ alkylsilyl group containing hydroquinone diglycidyl ether or a C₂ to C₁₈ alkylsilyl group containing resorcinol diglycidyl ether; a C₂ to C₁₈ alkylether group containing mononuclear aromatic diglycidyl ether, such as a C₂ to C₁₈ alkylether group containing hydroquinone diglycidyl ether or a C₂ to C₁₈ alkylether group containing resorcinol diglycidyl ether; a C₂ to C₁₈ alkoxy group containing mononuclear aromatic diglycidyl ether, such as, for example, a C₂ to C₁₈ alkoxy group containing resorcinol diglycidyl ether or a C₂ to C₁₈ alkoxy group containing hydroquinone diglycidyl ether; and a C₂ to C₁₈ cycloalkyl group containing mononuclear aromatic diglycidyl ether, such as, for example, a C₂ to C₁₈ cycloalkyl group containing hydroquinone diglycidyl ether, a C₂ to C₁₈ cycloalkyl group containing resorcinol diglycidyl ether, a C₂ to C₁₈ cycloalkylamino group containing mononuclear aromatic diglycidyl ether, such as a C₂ to C₁₈ cycloalkylamino group containing hydroquinone diglycidyl ether or a C₂ to C₁₈ cycloalkylamino group containing resorcinol diglycidyl ether; a C₃ to C₈ N-heterocycloalkyl group containing mononuclear aromatic diglycidyl ether, such as, for example, a C₃ to C₈ N-heterocycloalkyl group containing hydroquinone diglycidyl ether, a C₃ to C₈ N-heterocycloalkyl group containing resorcinol diglycidyl ether; and mixtures thereof.

3. Preferably, the epoxy component is chosen from a C₂ to C₁₈ alkyl group containing resorcinol or hydroquinone diglycidyl ether, and a C₂ to C₁₈ alkoxy group containing resorcinol or hydroquinone diglycidyl ether such that when the epoxy component and the second component are mixed to form a coating composition the resulting coating composition has an initial viscosity of 50 to 3000 cP at 25° C., preferably, 100 to 1000 cPs.

4. Preferably, to afford even lower viscosity coating compositions, the mononuclear aromatic diglycidyl ethers of the present invention have one alkyl containing group, such as one group chosen from alkyl, cycloalkyl, alkoxy, alkylether, N-heterocycloalkyl, alkylsulfide and alkylsilyl.

5. Preferably, the mononuclear aromatic diglycidyl ethers of the present invention have as substituents one or two C₂ or higher alkyl groups, one or two C₂ or higher alkoxy groups, two C₂ or higher alkylamino groups, one C₃ or higher N-heterocycloalkyl group, one or two C₂ or higher alkylsulfide groups, one or two C₂ or higher alkylsilyl groups, one or two C₂ or higher alkylether groups, or a combination of two of these groups.

6. Even more preferably, the mononuclear aromatic diglycidyl ethers of the present invention have one C₂ to C₈ alkyl containing group, one C₂ to C₈ cycloalkyl containing groups, one C₂ to C₈ alkoxy containing group, two C₂ to C₈ alkylamino containing groups, two C₂ or higher alkylamino containing groups, one C₃ or higher N-heterocycloalkyl group, one C₂ to C₈ alkylsulfide containing group, one C₂ to C₈ alkylsilyl containing group, or one C₂ to C₈ alkylether containing group.

7. In the coating compositions as set forth in any one of 1. to 6., above, the alkyl containing groups on the mononuclear aromatic diglycidyl ethers of the present invention preferably contain primary or secondary alkyl carbons and no tertiary alkyl carbons. For example, in the coating compositions as set forth in any one of 1. to 6., above, the alkyl containing groups on the resorcinol or hydroquinone diglycidyl ethers of the present invention may exclude a t-butyl group.

In accordance with another aspect of the present invention, methods of using the coating compositions of the present invention as set forth in any one of items 1. to 6., above, comprise mixing the epoxy component and the second component to form a coating composition, applying the coating composition to substrates, preferably, by spraying them, to form a coating layer and drying the coating layer. Suitable substrates may include steel and concrete. Preferably, the methods are field applications, meaning that they take place where the substrate is located, i.e. the applying is carried out in the field and not in a factory adapted for coating applications.

In the methods of the present invention, the alkyl, cycloalkyl, alkylamino, alkylsulfide, alkylsilyl, alkoxy, alkylether containing or N-heterocycloalkyl groups on the mononuclear aromatic diglycidyl ethers of the epoxy component of the coating compositions comprise, preferably, only primary or secondary alkyl carbons. For example, in the coating compositions used in the methods, the alkyl containing groups on the resorcinol or hydroquinone diglycidyl ethers of the present invention may exclude a t-butyl group.

In accordance with yet another aspect of the present invention, coatings comprise the dried coating layers made from the coating composition as set forth in any of items 1. to 6. of the present invention or made according to the methods of the present invention.

Unless otherwise indicated, conditions of temperature and pressure are ambient temperature and standard pressure. All ranges recited are inclusive and combinable.

Unless otherwise indicated, any term containing parentheses refers, alternatively, to the whole term as if no parentheses were present and the term without them, and combinations of each alternative. Thus, the term “(poly)alkoxy” refers to alkoxy, polyalkoxy, or mixtures thereof.

All ranges are inclusive and combinable. For example, the term “a range of 50 to 3000 cPs, or 100 or more cPs” would include each of 50 to 100 cPs, 50 to 3000 cPs and 100 to 3000 cPs.

As used herein, the term “alkyl group containing” refers to a chemical substituent which contains an alkyl group, such as, for example, an alkyl endgroup or an alkyl branch or side chain.

As used herein, the term “initial viscosity” refers to the viscosity of a coating composition of the epoxy component and the hardener component measured directly after mixing the two components.

As used herein, unless otherwise indicated, the term “solids content” refers to the total weight of epoxy resins, hardeners, catalysts or accelerators, and other non-volatile materials, such as pigments, silicones and non-volatile additives, expressed as a total wt. % of the coating composition. Solids excludes solvents, such as xylene, and non-reactive diluents, such as, for example, plasticizers like butyl adipates.

As used herein, unless otherwise indicated, “viscosity” refers to the result measured for a neat, undiluted composition using a Brookfield CAP 2000+ high-shear cone & plate viscometer, (Brookfield Engineering Laboratories, Inc. Middleboro, Mass.), calibrated as suggested in the manual (Brookfield CAP2000+ Viscometer, Model CAP 2000+, Operating Instructions, Manual # MO2-313B0707) and equipped with the spindles and speeds suggested in the manual for the expected initial viscosity.

As used herein, the phrase “wt. %” stands for weight percent.

The liquid epoxy resins of the present invention form coating compositions when mixed with a hardener component, e.g. an amine, that provide suitable ambient cure coatings at 100 wt. % solids, or 85 wt. % solids or higher, or 95 wt. % or higher, for field application. The low viscosity of the mononuclear aromatic diglycidyl ethers of the present invention provide coatings applicators with the ability to make coatings with much lower levels of VOCs, including zero VOCs, like solvents or diluents. The coating compositions also enable greater application flexibility, as they are less viscous than known aromatic diglycidyl ether coating compositions and so can be pumped or conveyed greater distances to reach higher or more difficult to reach objects and substrates.

The coating compositions of the present invention have initial ambient temperature viscosities, i.e. on mixing, that enable them to be sprayed even at very high solids contents of above 85 wt. %, or above 95 wt. %, or even above 97 wt. %. Such initial coating composition viscosities may range, for example, from 50 to 3000 cPs, preferably, 1000 cPs or less, or, preferably, 100 cPs or more, or, more preferably, 800 cPs or less.

Preferably, the epoxy component of the compositions of the present invention may have ambient temperature viscosities ranging from 50 to 3000 cPs, or, more preferably, 1000 cPs or less, or, even more preferably, 100 cPs or more, or, even more preferably, 800 cPs or less.

The mononuclear aromatic diglycidyl ethers, e.g. the diglycidyl ethers of alkyl or alkoxy group containing resorcinol or hydroquinone, may be substituted with one or two, preferably one, C₂ to C₁₈ alkyl or alkoxy group containing groups, C₂ to C₁₈ alkylsulfide group containing groups, C₂ to C₁₈ alkylsilyl group containing groups or C₂ to C₁₈ alkylether group containing groups, two C₂ to C₁₈ alkylamino group containing groups, or one C₃ to C₈ N-heterocycloalkyl group. To insure the lower viscosity of coating compositions containing them, the alkyl containing groups comprise, preferably, primary or secondary alkyl carbons and no tertiary alkyl carbons, such as, for example, n-propyl, n-hexyl groups or iso-butyl groups.

Alkoxy containing groups may include one or more than one oxygen and may be, for example, ethoxy or propoxy groups, or oligoglycols of the formula —(CH₂(CH₂)ₘO)ₙ(CH₂)ₓCH₃, where x is independently an integer from 0 to 3, m is independently an integer of from 1 to 3, n is independently an integer of 1 to 8, preferably, 1 to 6, such as, for example, a triethylene glycol group, or ethylene glycol alkyl ether group.

Alkylamino containing groups in the diglycidyl ethers of the present invention include 2 alkyl groups linked to the mononuclear aromatic ring via a single nitrogen atom.

Alkylsulfide containing groups in the diglycidyl ethers of the present invention may include any alkyl group linked to the mononuclear aromatic ring via a single sulfur atom.

Alkylsilyl containing groups in the diglycidyl ethers of the present invention may include from 1 to 3 alkyl groups linked to the mononuclear aromatic ring via a single silicon atom.

Alkylether containing groups in the diglycidyl ethers of the present invention may include any alkyl group linked to the mononuclear aromatic ring via a single oxygen atom.

The N-heterocycloalkyl groups in the diglycidyl ethers of the present invention are linked via a nitrogen atom to the mononuclear aromatic ring.

The mononuclear aromatic diglycidyl ethers of the present invention may be obtained, for example, by reacting any resorcinol or hydroquinone of formula (1) with an epihalohydrin to yield the diglycidyl ether resin:

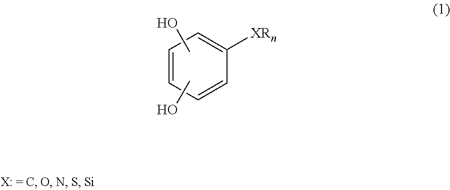

wherein X can be, independently, any of C, O, N, S or Si; R is chosen from H, a monovalent hydrocarbon, a monovalent alicyclic hydrocarbon, a divalent cycloaliphatic hydrocarbon ring of which X is a member, or a monovalent oxygen containing hydrocarbon radical having 18 or less, or, preferably, from 2 to 8 carbon atoms, for example, the alkoxy radical —(CH₂(CH₂)_{y}O)_{z}(CH₂)ₓCH₃, where x is independently an integer from 0 to 3, y is independently an integer of 1 to 3, and, z is independently an integer of 1 to 6; and wherein, further, n is chosen to complete the valence of the X atom, so that, for example, when X is C or Si, n totals 3 and R can be (cyclo)alkyl, alkoxy or hydrogen or R may form a cycloaliphatic ring with one hydrogen or monovalent alkyl group on the X carbon; where X is N, n can total 2 where R can be alkyl or cycloalkyl or n can total one where R forms a divalent cycloaliphatic ring that includes N; and where X is O or S, n is one and R can be alkyl.

The mononuclear aromatic diglycidyl ethers of the epoxy component of the present invention may comprise dimers, trimers and oligomers made from the diglycidyl ethers in accordance with the following formula:

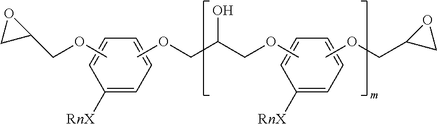

Where m is 0 to 5, preferably 0 to 2, and n, R and X are as defined for formula (1), above.

The high solids coating compositions of the present invention may include up to 15 wt. % solvent or diluent, preferably, up to 5 wt. %, or, more preferably, up to 3 wt. %. Suitable solvents and diluents may include, for example, methyl ethyl ketone (mek), xylene, toluene, aromatic hydrocarbons and petroleum distillates, and benzyl alcohol. Suitable reactive diluents may include, for example, cresol glycidyl ether, and C₁₂-C₁₄ aliphatic glycidyl ether.

The epoxy component of the present invention may also further comprise any conventional epoxy resins, such as bisphenol A or F epoxy resins, phenolic epoxy resins, polyphenolic epoxy resins, novolac epoxy resins and cresol epoxy resins, as well as mixtures thereof. Such compositions may have higher initial viscosities than two component mixtures containing only hardener and the mononuclear aromatic diglycidyl ethers of the present invention. In such compositions, the total initial viscosity of a coating composition would be lowered by including the mononuclear aromatic diglycidyl ethers of the present invention.

The second component comprises one or more hardener which may be any conventional hardener for epoxy resins. Conventional hardeners may be, for example, any amine or mercaptan with at least two epoxy reactive hydrogen atoms per molecule, anhydrides, phenolics. Preferably, the hardener is an amine where the nitrogen atoms are linked by divalent hydrocarbon groups that contain at least 2 carbon atoms per subunit, such as aliphatic, cycloaliphatic or aromatic groups. Preferably, polyamines contain from 2 to 6 amine nitrogen atoms per molecule, from 2 to 8 amine hydrogen atoms per molecule, and 2 to about 50 carbon atoms.

Examples of suitable polyamines include aliphatic polyamines such as, for example, ethylene diamine, diethylene triamine, triethylene tetramine, tetraethylene pentamine, pentaethylene hexamine, dipropylene triamine, tributylene tetramine, hexamethylene diamine, dihexamethylene triamine, 1,2-propane diamine, 1,3-propane diamine, 1,2-butane diamine, 1,3-butane diamine, 1,4-butane diamine, 1,5-pentane diamine, 1,6-hexane diamine, 2-methyl-1,5-pentanediamine, and 2,5-dimethyl-2,5-hexanediamine; cycloaliphatic polyamines such as, for example, isophoronediamine, 1,3-(bisaminomethyl)cyclohexane, 4,4′-diaminodicyclohexylmethane, 1,2-diaminocyclohexane, 1,4-diamino cyclohexane, isomeric mixtures of bis(4-aminocyclohexyl)methanes, bis(3-methyl-4-aminocyclohexyl)methane (BMACM), 2,2-bis(3-methyl-4-aminocyclohexyl)propane (BMACP), 2,6-bis(aminomethyl)norbornane (BAMN), and mixtures of 1,3-bis(aminomethyl)cyclohexane and 1,4-bis(aminomethyl)cyclohexane, including cis and trans isomers of the 1,3- and 1,4-bis(aminomethyl)cyclohexanes; bicyclic amines, such as, for example, 3-azabicyclo[3.3.1]nonane; bicyclic imines, such as, for example, 3-azabicyclo[3.3.1]non-2-ene; bicyclic diamines, such as, for example, 3-azabicyclo[3.3.1]nonan-2-amine; heterocyclic diamines such as, for example, 3,4 diaminofuran and piperazine; polyamines containing amide linkages derived from “dimer acids” (dimerized fatty acids) which are produced by condensing the dimer acids with ammonia and then optionally hydrogenating; adducts of the above amines with epoxy resins, epichlorohydrin, acrylonitrile, acrylic monomers, ethylene oxide, and the like, such as, for example, an adduct of isophoronediamine with a diglycidyl ether of a dihydric phenol, or corresponding adducts with ethylenediamine or m-xylylenediamine; araliphatic polyamines such as, for example, 1,3-bis(aminomethyl)benzene, 4,4′diaminodiphenyl methane and polymethylene polyphenylpolyamine; aromatic polyamines such as, for example, 4,4′-methylenedianiline, 1,3-phenylenediamine and 3,5-diethyl-2,4-toluenediamine; amidoamines such as, for example, condensates of fatty acids with diethylenetriamine, triethylenetetramine, etc; polyamides such as, for example, condensates of dimer acids with diethylenetriamine, triethylenetetramine; oligo(propylene oxide)diamine; and Mannich bases, such as, for example, the condensation products of a phenol, formaldehyde, and a polyamine or phenalkamines. Mixtures of more than one diamine and/or polyamine can also be used.

Other curing agents and accelerators that may be used in the second component with the hardener described above may include quaternary ammonium and phosphonium salts, such as, for example, tetraethylammonium chloride, tetraethylammonium bromide, tetraethylammonium iodide, tetraethylammonium hydroxide, tetra(n-butyl) ammonium chloride, tetra(n-butyl)ammonium bromide, tetra(n-butyl)ammonium iodide, tetra(n-butyl)ammonium hydroxide, tetra(n-octyl) ammonium chloride, tetra(n-octyl) ammonium bromide, tetra(n-octyl)ammonium iodide, tetra(n-octyl)ammonium hydroxide, methyltris(n-octyl)ammonium chloride, bis(tetraphenylphosphoranylidene) ammonium chloride, ethyltri-p-tolyl phosphonium acetate/acetic acid complex, and ethyl triphenylphosphonium acetate/acetic acid complex; phosphines; nitrate salts, such as, for example, calcium nitrate; and phosphites, such as, for example, triphenyl phosphite or combinations thereof as described in U.S. Pat. Nos. 5,208,317, 5,109,099 and 4,981,926, phenolic compounds such as t-butylphenol, bisphenol A, salicylic acid and aminophenols such as 2,4,6-tris(dimethylamionomethyl)phenol.

The stiochiometric ratio of epoxy resin in the epoxy component to the hardener in the second component of the coating compositions may range from 0.5:1 to 1:0.5, preferably, from 0.7:1 to 1:0.7, or, more, preferably, from 0.8:1 to 1:0.8, or, most preferably 0.90:1 to 1:0.90. The coating compositions of the present invention may be clearcoats, wherein they have no pigments or may include pigments or fillers that do not alter clarity, such as subcritical amounts of pigments having a refractive index of less than 1.7, e.g. silica, talc, calcium carbonate or alumina.

The coating compositions of the present invention can be pigmented/filled other additives including pigments, which may be organic or inorganic and may functionally contribute to opacity, e.g. titanium dioxide or hollow core or void containing polymer pigments, and color, e.g. iron oxides, micas, aluminum flakes and glass flakes, silica pigments, or organic pigments, such as phthalocyanines, and corrosion protection, e.g. zinc, phosphates, molybdates, chromates, vanadates, cerates, in addition to durability and hardness such as silicates. Generally, when pigments are included in the coating compositions, the weight ratio of pigment to the total solid of epoxy resin and hardener may range from 0.1:1 to 5:1, preferably, up to 2:1.

The coating compositions of the present invention may include other conventional additives in conventional amounts, including, for example, rheology modifiers, dispersants, silicones or wetting agents, adhesion promoters, or flow and leveling agents.

The coating compositions of the present invention enjoy low viscosity; thus, they are suitable for use in field applications such as coatings for use on substrates such as concrete, metal, machinery, heavy mass parts, ships, buildings under construction, bridges, tanks, anti-corrosive applications e.g. pipe coatings, and flooring and maintenance coating applications.

Preferably, the methods comprise applying the coating compositions to substrates in the field, such as, for example, pipes, tanks, ships, heavy mass parts, such as girders, machinery, such as heavy equipment, bridges, concrete structures, and buildings.

In one example of the methods useful to make protective finishes, the coating compositions may be used as a primer, and the methods further comprise applying additional layers over the primer.

The following examples are used to illustrate the present invention. Unless otherwise indicated, all temperatures are ambient temperatures and all pressures are 1 atmosphere.

### EXAMPLE 1

### 2,2′-(((4-hexyl-1,3-phenylene)bis(oxy))bis(methylene)) bis(oxirane)

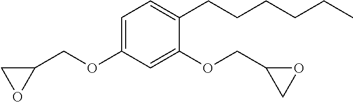 [SMILES: CCCCCCc1ccc(OCC2CO2)cc1OCC1CO1]

A 500 mL 3-necked round bottom flask equipped with a condenser, addition funnel and septum under nitrogen was charged in order with 4-hexylresorcinol (10.0 g, 51.5 mmol), Dowanol PM (a mixture of propylene glycol methyl ether isomers sold by Dow Chemical, Midland, Mich.) (54.7 mL, 556 mmol), epichlorohydrin (161.3 mL, 2.06 mol), and water (3.0 mL, 165 mmol). The orange solution was then heated to 52° C. before addition of sodium hydroxide (20% solution, 18.5 g, 92.7 mmol). The reaction mixture was heated for 2.5 h after addition was complete.

The reaction mixture was transferred to a separatory funnel where the bottom aqueous layer and the precipitate were removed from the top organic layer. The organic layer was then returned to the flask and was re-heated to 52° C. and another addition of sodium hydroxide (20% solution, 5.15 g, 25.7 mmol) was added dropwise maintaining the set temperature (˜15 minutes). The reaction was then heated and stirred for an additional 1 hour after addition was complete. The reaction was then cooled to room temperature (RT) before transferring the reaction mixture to a separatory funnel where the bottom aqueous layer and the precipitate were removed from the top organic layer. The organic layer was then washed with water (2×75 mL) (the separation was slow) before concentrating, via rotovap (Buchi Rotavapor R-210, BUCHI Labortechnik AG, Flawil, CH) resulting in an orange liquid. The crude orange liquid was passed through a large diameter (˜11″), 2″ thick plug of silica in a Buchner funnel using methylene chloride as the eluent. About 500 mL of eluent were collected after 1^{st} appearance of product via TLC. The collected eluent was concentrated under reduced pressure to yield a yellow liquid. Yield (4.8 g, 25.8%).

### EXAMPLE 2

### 2,2′-(((5-pentyl-1,3-phenylene)bis(oxy))bis(methylene)) bis(oxirane)

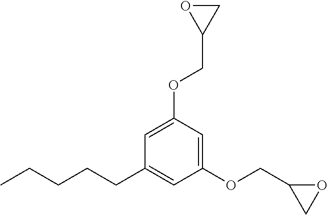 [SMILES: CCCCCc1cc(OCC2CO2)cc(OCC2CO2)c1]

A 500 mL 3-necked round bottom flask equipped with a condenser, addition funnel and septum under nitrogen was charged in order with: 1,3-dihydroxy-5-pentylbenzene (6.0 g, 33.3 mmol), Dowanol PM solvent (35.4 mL, 359.5 mmol), epichlorohydrin (106.5 mL, 1.33 mol), and water (1.9 mL, 106.5 mmol). The colorless solution was then heated to 52° C. before addition of sodium hydroxide (20% solution, 12.0 g, 59.9 mmol). The solution was then stirred at 52° C. for an additional 2 hours. The reaction was then cooled to RT before it was transferred to a separatory funnel where the bottom aqueous layer and the precipitate were removed from the top organic layer. Organic layer was then returned to the flask and was re-heated to 52° C. and another addition of sodium hydroxide (20% solution, 3.3 g, 16.6 mmol) was added dropwise maintaining the set temperature (˜10 minutes). The reaction was then heated and stirred for an additional 1 hour after addition was complete. The reaction was then cooled to RT before transferring the reaction mixture to a separatory funnel where the bottom aqueous layer and the precipitate were removed from the top organic layer. The organic layer was then washed with water (2×50 mL) (the separation was slow) before concentrating, via rotovap (Buchi rotavaporator), resulting in a pale brown liquid. The brown liquid was then purified by flash chromatography (Biotage HP-Sil 100 g Snap™ column, Biotage, Uppsala, Sweden), CH₂Cl₂ isocratic) to yield a yellow liquid. Yield (5.0 g, 51.7%).

### EXAMPLE 3

### 2,2′-(((4-(2,4,4-trimethylpentan-2-yl)-1,3-phenylene)bis(oxy))bis(methylene))bis(oxirane)

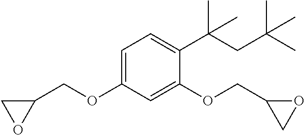 [SMILES: CC(C)(C)CC(C)(C)c1ccc(OCC2CO2)cc1OCC1CO1]

A 500 mL 3-necked round bottom flask equipped with a condenser, addition funnel and septum under nitrogen was charged in order with: 2-(1,1,3,3-tetramethyl-butyl)-benzene-1,4-diol (7.0 g, 31.5 mmol), Dowanol PM solvent (33.5 mL, 340.3 mmol), epichlorohydrin (98.7 mL, 1.26 mol), and water (1.8 mL). The colorless solution was then heated to 52° C. before addition of sodium hydroxide (20% solution, 11.3 g, 56.7 mmol). The solution was then stirred at 52° C. for an additional 2 hours. The reaction was then cooled to RT before it was transferred to a separatory funnel where the bottom aqueous layer and the precipitate were removed from the top organic layer. Organic layer was then returned to the flask and was re-heated to 52° C. and another addition of sodium hydroxide (20% solution, 3.2 g, 15.8 mmol) was added dropwise maintaining the set temperature (˜10 minutes). The reaction was then heated and stirred for an additional 1 hour after addition was complete. The reaction was then cooled to RT before transferring the reaction mixture to a separatory funnel where the bottom aqueous layer and the precipitate were removed from the top organic layer. The organic layer was then washed with water (2×50 mL) (the separation was slow) before concentrating, via rotovap, resulting in a purple/red liquid. The purple/red liquid was then purified by flash chromatography. The first column was run with 1% methanol in methylene chloride isocratically through a 100 g Snap™ HP-Sil silica column. The first 7 fractions were combined and concentrated. The concentrate was then run through another 100 g column using a gradient of 20-30% ethyl acetate in hexanes. Fractions 5-10 were combined and concentrated under reduced pressure and heat to yield an orange liquid. Yield (4.4 g, 41.8%).

### EXAMPLE 4

### 2,2′-(((4-ethyl-1,3-phenylene)bis(oxy))bis(methylene))bis(oxirane)

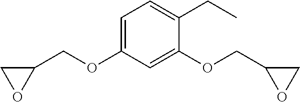 [SMILES: CCc1ccc(OCC2CO2)cc1OCC1CO1]

A 500 mL 3-necked round bottom flask equipped with a condenser, addition funnel and septum under nitrogen was charged in order with: 4-ethylresorcinol (10.0 g, 72.4 mmol), Dowanol PM solvent (76.9 mL), epichlorohydrin (226.8 mL), and water (4.2 mL). The colorless solution was then heated to 52° C. before addition of sodium hydroxide (20% solution, 26.1 g, 130.3 mmol) which caused an immediate color change to red. The solution was then stirred at 52° C. for an additional 2 hours. The reaction was then cooled to RT before it was transferred to a separatory funnel where the bottom aqueous layer and the precipitate were removed from the top organic layer. Organic layer was then returned to the flask and was re-heated to 52° C. and another addition of sodium hydroxide (20% solution, 7.2 g, 36.2 mmol) was added dropwise maintaining the set temperature (˜10 minutes). The reaction was then heated and stirred for an additional 1 hour after addition was complete. The reaction was then cooled to RT before transferring the reaction mixture to a separatory funnel where the bottom aqueous layer and the precipitate were removed from the top organic layer. Organic layer was then returned to the flask and was re-heated to 52° C. and a 3rd addition of sodium hydroxide (20% solution, 2.9 g, 14.5 mmol) was added dropwise maintaining the set temperature (˜10 minutes). The reaction was then heated and stirred for an additional 1 hour after addition was complete. The organic layer was then washed with water (3×250 mL) before concentrating, via rotovap (Buchi Rotavapor), resulting in a yellow liquid. The yellow liquid was then purified by flash chromatography. The first column was run with a gradient of 5-15% % ethyl acetate in methylene chloride through a 330 g Reveleris™ (W.R. Grace Scientific, Baltimore, Md.) silica column. The fractions of the first peak were combined and concentrated under reduced pressure and heat to yield a colorless liquid. Yield (10.2 g, 56.3).

### EXAMPLE 5

### 2,2′-(((2-propyl-1,3-phenylene)bis(oxy))bis(methylene))bis(oxirane)

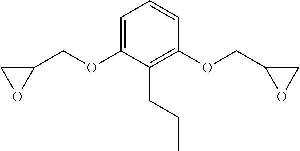 [SMILES: CCCc1c(OCC2CO2)cccc1OCC1CO1]

A 500 mL 3-necked round bottom flask equipped with a condenser, addition funnel and septum under nitrogen was charged in order with: 2-t-butylhydroquinone (9.15 g, 60.1 mmol), Dowanol PM solvent (63.9 mL), epichlorohydrin (188.4 mL), and water (3.5 mL). The colorless solution was then heated to 52° C. before addition of sodium hydroxide (20% solution, 21.6 g, 108.2 mmol) which caused an immediate color change to red. The solution was then stirred at 52° C. for an additional 2 hours. The reaction was then cooled to RT before it was transferred to a separatory funnel where the bottom aqueous layer and the precipitate were removed from the top organic layer. Organic layer was then returned to the flask and was re-heated to 52° C. and another addition of sodium hydroxide (20% solution, 6.0 g, 30.1 mmol) was added dropwise maintaining the set temperature (˜10 minutes). The reaction was then heated and stirred for an additional 1 hour after addition was complete. The reaction was then cooled to RT before transferring the reaction mixture to a separatory funnel where the bottom aqueous layer and the precipitate were removed from the top organic layer. Organic layer was then returned to the flask and was re-heated to 52° C. and a 3rd addition of sodium hydroxide (20% solution, 2.4 g, 12.0 mmol) was added dropwise maintaining the set temperature (˜10 minutes). The reaction was then heated and stirred for an additional 1 hour after addition was complete. The organic layer was then washed with water (3×250 mL) before concentrating, via rotovap (Buchi Rotavapor), resulting in a brown liquid. The brown liquid was then purified by flash chromatography. The first column was run with a gradient of 5-15% ethyl acetate in methylene chloride through a 330 g Reveleris™ silica column. The fractions of the second peak were combined and concentrated under reduced pressure and heat to yield a yellow liquid. Yield (10.2 g, 61.0%).

### EXAMPLE 6

### 2,2′-(((2-(tert-butyl)-1,4-phenylene)bis(oxy))bis(methylene))bis(oxirane)

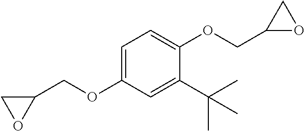 [SMILES: CC(C)(C)c1cc(OCC2CO2)ccc1OCC1CO1]

A 500 mL 3-necked round bottom flask equipped with a condenser, addition funnel and septum under nitrogen was charged in order with: 2-t-butylhydroquinone (10.0 g, 60.2 mmol), Dowanol PM solvent (63.9 mL), epichlorohydrin (188.5 mL), and water (3.5 mL). The colorless solution was then heated to 52° C. before addition of sodium hydroxide (20% solution, 21.7 g, 108.3 mmol) which caused an immediate color change to red. The solution was then stirred at 52° C. for an additional 2 hours. The reaction was then cooled to RT before it was transferred to a separatory funnel where the bottom aqueous layer and the precipitate were removed from the top organic layer. Organic layer was then returned to the flask and was re-heated to 52° C. and another addition of sodium hydroxide (20% solution, 6.0 g, 30.1 mmol) was added dropwise maintaining the set temperature (˜10 minutes). The reaction was then heated and stirred for an additional 1 hour after addition was complete. The reaction was then cooled to RT before transferring the reaction mixture to a separatory funnel where the bottom aqueous layer and the precipitate were removed from the top organic layer. Organic layer was then returned to the flask and was re-heated to 52° C. and a 3rd addition of sodium hydroxide (20% solution, 2.4 g, 12.0 mmol) was added dropwise maintaining the set temperature (˜10 minutes). The reaction was then heated and stirred for an additional 1 hour after addition was complete. The organic layer was then washed with water (3×250 mL) before concentrating, via rotovap (Buchi Rotavapor), resulting in a brown liquid. The brown liquid was then purified by flash chromatography. The first column was run with a gradient of 10-20% ethyl acetate in methylene chloride through a 330 g Reveleris™ (Grace Scientific) silica column. The fractions of the second peak were combined and concentrated under reduced pressure and heat to yield a dark yellow liquid. Yield (13.2 g, 78.9%).

The viscosities of the neat diglycidyl ethers in the Examples were measured using a Brookfield CAP 2000+ cone-and-plate viscometer using the spindles and speeds suggested in the Brookfield user manual (Brookfield CAP2000+ Viscometer, Model CAP 2000+, Operating Instructions, Manual # M02-313B0707). The viscosities are given in Table 1, below.

TABLE 1
Diglycidyl Ether Viscosities:

| | | | Viscosity | | |
|---|---|---|---|---|---|
| | Purity % | | (25° C., | | |
| Example | (LC-MS Diode¹) | Amount | cP) | Spindle² | RPM² |
| 1 | 100.0 | 4.8 g | 108 | — | — |
| 2 | 98.9 | 5.0 g | 152 | — | — |
| 3 | 94.8% | 4.4 g | 2550 | — | — |
| 4 | 100 | 10.2 | 83 | 01 | 120 |
| 5 | 96.2 | 10.2 | 80 | 01 | 120 |
| 6 | 97.2 | 13.2 | 420 | 01 | 120 |

¹Liquid Chromatography-Mass Spectrometry results: Waters Alliance e2595 Separatpr Module using an XBridge ™ C18 3.5 μm column (Waters Corporation, Milford, MA), Waters 3100 Mass Detector, Waters 2928 Photodiode Array Detector;
²Spindle and RPM were as directed in the Brookfield user manual.

As shown in Table 1, above, all of the diglycidyl ethers of Examples 1 to 6 exhibit surprisingly low viscosities in their neat form. The diglycidyl ethers listed in Table 1, above were mixed using a dual axis mixer (SpeedMixer, Model # DAC 150 FVZ-K, FlackTek Inc., Landrum, S.C.) at room temperature for 2 minutes at 2000 rpm with Polypox™ H013, an accelerated Mannich base hardener with an amine hydrogen equivalent weight (ANEW) of 90 (UPPC, Dow Chemical Company, Midland, Mich.) at a 1:1 epoxy to amine equivalent ratio and were tested for resin and coating properties. Where measurement of coating film properties is indicated, the coating composition was applied and drawn down with a wire wound rod to a cold rolled steel substrate to give a film having a dry-film thickness of 50 μm. The coatings were allowed to dry at ambient temperature (22° C.) for 14 days prior to testing the coatings.

The following test methods were used:

Mandrel Bend Flexibility:

(ASTM D-522, ASTM International, West Conshohocken, Pa., 2008) was measured using a BYK Gardner Conical Mandrel Bending Tester, PF-5750, (BYK-Gardner USA, Columbia, Md.). The coatings were bent around the small diameter end of the tester (3.175 mm to 20 mm) from the largest dimension to the smallest, and the largest diameter it failed was reported. The result was noted a “pass” if the entire coating was intact, or “fail” if the coating cracked.

Coating Composition Initial Viscosity (cP):

Was measured after mixing as described above with a Brookfield CAP2000+ viscometer (Brookfield Engineering, Middleboro, Mass.) Spindle #01 was used at 100 rpm.

Hardness and Hardness Development:

A Fischer microindenter (Helmut-Fischer Fischerscope™ HM2000 XYp, Fischer Technology, Inc. Windsor, Conn.) was used to apply a 5 mN load on the coating at a rate of 0.25 mN/sec. The indenter tip was then held at the maximum load for 5 seconds before retracting at the same load decrease rate. Martens hardness was reported. For hardness development measurement, hardness was measured as a function of cured days, and the number of days required to reach final hardness was reported.

Impact Resistance

(ASTM D-2794, ASTM International, 2010): Was measured using a Gardner dart falling weight impact tester (PF-1125, BYK Gardner Inc., Columbia, Md.). The maximum impact force, and product of the weight of the dart and maximum falling distance without creating crack or delamination was reported.

Adhesion

(ASTM D-3359, ASTM International, 2009): A cross hatch adhesion test (BYK Gardner tester, Columbia, Md.) was performed and the result was rated from 5B to 0B with respect to perfect to poor adhesion.

Chemical Resistance

(ASTM D-1308, ASTM International, 2007): The chemical

Resistance with brake fluid test was performed on the coatings on cold rolled steel panels on the lab bench top for 24 hours. The panels were laid out at room temperature and the chemical spots were placed on the coating and left for 24 hours with a cover over each droplet (to inhibit evaporation). After a 24 hour exposure time, the covers were removed, the chemicals were rinsed off and the panel was patted dry with a clean cloth. The panel was observed for whitening or obvious changes in coating appearance. The chemicals used include brake fluid (Prestone” synthetic brake fluid, dot 3, Prestone Product Corp., Danbury, Conn.). The rating from 1 to 5 was used where 1 is nothing visible and 5 is severe damage.

The results of testing are listed in Table 2, below. D.E.R.™ 331 resin, a bisphenol A liquid epoxy resin with an epoxide equivalent weight of 187 and viscosity of 11,000 cP (Dow Chemical, Midland, Mich.), was used as the control Example 8 for property comparison. In general, the diglycidyl ethers of the present invention (Examples 1 to 6) provide reasonably good coating properties at ambient cure, especially when looking at final Martens hardness and adhesion data. Compared to known epoxy resins, the diglycidyl ethers give comparable or better Mandrel Bend and Impact Resistance and maintain good chemical (Brake Fluid) resistance. However, the diglycidyl ethers of the present invention (Examples 1 to 6) have extremely low viscosity and provide in all Examples dramatically lower viscosity in a coating composition having a given hardener and solids content.

TABLE 2
Coating and Epoxy Resin Properties

| | Example | | | | | | |
|---|---|---|---|---|---|---|---|
| Test | 1 | 2 | 3 | 4 | 5 | 6 | 8* |
| Mandrel Bend | Pass | Pass | Fail | Fail | Fail | Fail | Fail |
| Impact | 0.18 | 1.35 | 0 | 0 | 0 | 0 | 0 |
| Resistance | | | | | | | |
| (kgm) | | | | | | | |
| Cross Hatch | 1B | 4B | 0B | 0B | 0B | 0B | 0B |
| Adhesion | | | | | | | |
| Epoxy Resin | 108 | 152 | 2550 | 83 | 80 | 420 | 11000 |
| Viscosity (cP) | | | | | | | |
| Initial | 339 | 308 | 1260 | 199 | 251 | 570 | 4987 |
| Formulation | | | | | | | |
| Viscosity (cP) | | | | | | | |
| Final Martens | 144 | 143 | 217 | 130 | 145 | 172 | 211 |
| Hardness | | | | | | | |
| (N/mm²) | | | | | | | |
| Brake Fluid | 3 | 5 | 5 | 5 | 5 | 5 | 3 |

*Comparative Example

1. A two component liquid coating composition comprising an epoxy component of one or more compounds chosen from a C₂ to C₁₈ alkyl group containing mononuclear aromatic diglycidyl ether, a C₂ to C₁₈ cycloalkyl group containing mononuclear aromatic diglycidyl ether, a C₂ to C₁₈ alkoxy group containing mononuclear aromatic diglycidyl ether, and mixtures thereof, and, as a second component, a hardener,
wherein the coating composition has a solids content of 85 wt. % or higher, such that when the epoxy component and the second component are mixed to form a coating composition the resulting coating composition has an initial viscosity at 25° C. (Brookfield CAP 2000+ high-shear cone & plate viscometer) of from 50 to 3,000 cPs.

2. The composition as claimed in claim 1, wherein the epoxy component comprises one or more compounds chosen from a C₂ to C₁₈ alkyl group containing mononuclear aromatic diglycidyl ether, a C₂ to C₁₈ cycloalkyl group containing mononuclear aromatic diglycidyl ether, a C₂ to C₁₈ alkoxy group containing mononuclear aromatic diglycidyl ether, a C₂ to C₁₈ alkylsulfide group containing mononuclear aromatic diglycidyl ether, a C₂ to C₁₈ alkylamino group containing mononuclear aromatic diglycidyl ether, a C₂ to C₁₈ alkylsilyl group containing mononuclear aromatic diglycidyl ether, a C₃ to C₈ N-heterocycloalkyl group containing mononuclear aromatic diglycidyl ether, and mixtures thereof.

3. The composition as claimed in claim 1, wherein the epoxy component is one or more compounds chosen from a C₂ to C₁₈ alkyl group containing resorcinol diglycidyl ether, C₂ to C₁₈ alkyl group containing hydroquinone diglycidyl ether, a C₂ to C₁₈ alkoxy group containing resorcinol diglycidyl ether, a C₂ to C₁₈ alkoxy group containing hydroquinone diglycidyl ether, and mixtures thereof.

4. The coating composition as claimed in claim 1, wherein the mononuclear aromatic diglycidyl ethers have as substituents one or two C₂ or higher alkyl containing groups, one or two C₂ or higher cycloalkyl containing groups, one or two C₂ or higher alkoxy containing groups, one or two C₂ or higher alkylsulfide containing groups, one or two C₂ or higher alkylsilyl containing groups, one or two C₂ or higher alkylether containing groups, a combination of two of the foregoing groups, two C₂ or higher alkylamino containing groups, or one C₃ to C₈ N-heterocycloalkyl group.

5. The coating composition as claimed in claim 1, wherein the mononuclear aromatic diglycidyl ethers have one C₂ to C₈ alkyl containing group, one C₂ to C₈ cycloalkyl containing group, one C₂ to C₈ alkoxy containing group, one C₂ to C₈ alkylsulfide containing group, one C₂ to C₈ alkylsilyl containing group, one C₂ to C₈ alkylether containing group, or one C₃ to C₈ N-heterocycloalkyl group.

6. The coating composition as claimed in claim 1, wherein the mononuclear aromatic diglycidyl ethers of the epoxy component of the coating compositions contain one or two alkyl groups and the alkyl groups contain primary or secondary alkyl carbons.

7. The coating composition as claimed in claim 1, having a solids content of 95 wt. % or higher.

8. The coating composition as claimed in claim 1, having an initial viscosity at 25° C. of from 100 to 1000 cP.

9. A method of using the coating composition as claimed in claim 1 comprising mixing the epoxy component and the second component to form a coating composition, applying the coating composition to a substrate to form a coating layer and drying the coating layer.

10. The method as claimed in claim 9, wherein the applying is carried out in the field.

11. A coating comprising the dried coating layer as claimed in claim 9.
